(19) United States
(12) Patent Application Publication
(10) Pub. No.: US 2009/0106082 A1
(43) Pub. Date: Apr. 23, 2009

(54) SYSTEM AND METHOD TO FACILITATE TARGETED ADVERTISING

(76) Inventors: Thad E. Senti, Zeeland, MI (US); Roy Pereira, Grand Rapids, MI (US)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 11/877,197

(22) Filed: Oct. 23, 2007

(51) Int. Cl. G06Q 30/00

(52) U.S. Cl. 705/10; 705/14

(57) ABSTRACT

A method to facilitate targeted advertising can include receiving a plurality of schedule files that include scheduling information for at least one respective advertising media asset. Target attribute data is associated with each of the plurality of schedule files to identify at least one characteristic of an intended target audience of media content represented in each of the plurality of schedule files. Profile data associated with each of a plurality of uniquely identifiable network devices is received. The profile data characterizes known attributes of an audience serviced by each of the plurality of uniquely identifiable network devices. A plurality of playlist data files are generated based on analysis of the target data and the profile data. Each of the plurality of playlist data files includes scheduling information for at least one respective advertising media asset scheduled for playing out by at least one of the plurality of uniquely identifiable network devices.

### TECHNICAL FIELD

The present invention relates generally to distribution of content and, more particularly, to a system and method to facilitate targeted advertising.

### BACKGROUND

Advertising is utilized in a variety of media to tell about different products or services so as to promote sales. The intended audience of an advertisement can also vary according to the media and generally ranges from global advertisements to individualized targeted advertisements. Global advertisements direct the same advertisements to all persons that may perceive the advertisement. Targeted advertisements seek to target a given advertisement to a specific audience to which the product or service being sold has been determined to be relevant. There have been significant efforts to develop algorithms to determine or predict whether a given ad would be relevant to a particular consumer or segment of consumers based on characteristics of the consumer, such as demographics, preferences, income and/or purchasing history. Advertisers can access information about potential customers to identify smaller but better defined target audiences, leading to ads that are more generally relevant to viewers. In certain types of media, consumer can proactively select what advertisements they want to receive.

Even if the relevance of an advertisement to a given consumer or group of consumers can be predicted reliably, there still exists a need to distribute such advertisement so that it can be presented to the appropriate prospective consumers.

### SUMMARY

The invention relates to systems and methods to facilitate targeted advertising. In one system, a promotion scheduler that resides upstream from a subscriber or a group of subscribers generates a plurality of playlists that provide scheduling information for one or more targeted advertisements. The type of media can vary according to the type playout device located downstream from the promotion scheduler. For example, the playlist defines a pre-constructed set of ads that can be inserted into program content. The ads identified in a given playlist can be targeted for a given subscriber or a group of subscribers (e.g., grouped by demographic profile and/or by geographic region).

One aspect of the present invention relates to a method to facilitate targeted advertising. The method includes receiving a plurality of schedule files that include scheduling information for at least one respective advertising media asset. Target attribute data is associated with each of the plurality of schedule files to identify at least one characteristic of an intended target audience of media content represented in each of the plurality of schedule files. Profile data associated with each of a plurality of uniquely identifiable network devices is received. The profile data characterizes known attributes of an audience serviced by each of the plurality of uniquely identifiable network devices. A plurality of playlist data files are generated based on analysis of the target data and the profile data. Each of the plurality of playlist data files includes scheduling information for at least one respective advertising media asset scheduled for playing out by at least one of the plurality of uniquely identifiable network devices.

Another aspect of the invention provides a system to facilitate targeted advertising. The system includes at least one scheduling source that provides a plurality of schedule files. Target attribute data is associated with each of the plurality of schedule files to identify at least one attribute of an intended target audience for media content defined by scheduling data in each of the plurality of schedule files. Profile data is defined for each of the plurality of uniquely identifiable network devices to identify known attributes of consumers serviced by each of the plurality of uniquely identifiable network devices. A promotion scheduler in communication with a plurality of uniquely identifiable network devices generates a plurality of targeted playlist data files based on analysis of the target attribute data and the profile data. Each of the plurality of playlist data files includes scheduling data for playing out at least one media asset by at least one of the plurality of uniquely identifiable network devices.

Another aspect of the invention provides a system to facilitate targeted advertising. The system includes means for ingesting a plurality of schedule files that include scheduling information for at least one advertising media asset. Target attribute data is associated with each of the plurality of schedule files to identify at least one characteristic of an intended target audience of the at least one media asset in each of the plurality of schedule files. The system also includes means for managing profile data associated with each of a plurality of uniquely identifiable network devices, the profile data characterizing known attributes of an audience serviced by each of the plurality of uniquely identifiable network devices. The system also includes means for generating a plurality of playlist data files based on analysis of the target data and the profile data. Each of the plurality of playlist data files includes scheduling data for the at least one advertising media asset scheduled for playout by at least one of the plurality of uniquely identifiable network devices.

### BRIEF DESCRIPTION OF THE DRAWINGS

FIG. 1 is a schematic block diagram of a system for generating playlists according to an aspect of the invention.

FIG. 2 depicts another example of a system for generating playlists according to an aspect of the invention.

FIG. 3 depicts an example of an architecture of a system for generating and distributing playlists and media content according to an aspect of the invention.

FIG. 4 depicts an example of a system for distributing targeted advertising for a digital signage system according to an aspect of the invention.

FIG. 5 depicts an example of a system for distributing targeted advertising with the distribution of linear media content according to an aspect of the invention.

FIG. 6 is a functional block diagram depicting the playout of targeted advertising and streamable media content according to an aspect of the invention.

FIG. 7 depicts an example of a system to facilitate generation and distribution of targeted advertising content and ad-enabled program content according to an aspect of the invention.

FIG. 8 is an example of pseudo code for a playlist that can be generated according to an aspect of the invention.

FIG. 9 is another example of pseudo code for a playlist that can be generated in a different format according to an aspect of the invention.

FIG. 10 is a flow diagram depicting a method of generating and distributing playlists according to an aspect of the invention.

FIG. 11 is a flow diagram of a method of utilizing a playlist to present advertising media content according to an aspect of the invention.

### DETAILED DESCRIPTION

This invention relates generally to systems and methods to facilitate targeted advertising. In the example embodiments described herein, the systems and methods generate targeted or semi-targeted playlist data files that can be utilized to distribute or dispatch targeted advertisements in one or more types of media. Each playlist data file can include data that identifies and/or includes one or more advertisement intended to reach a target audience that has been predetermined to substantially match profile characteristics of an audience associated with at least one playout device to which the playlist data file can be sent. Playlists are generated upstream relative to one or more playout devices with each playlists specifying at least one advertisement scheduled for presentation by the downstream playout device. Each playlist data file is generated based on an analysis of the intended target for a scheduled advertisement and profile data that describes known attributes for one or more downstream target device. While the approach described herein can be utilized to generate individualized or customized playlist data files for each consumer, the approach has more immediate applicability in specifying playlists for groups of clients or consumers based upon an aggregate profile for such groups of consumers or clients.

Additionally, it will be understood that the approach described herein is applicable to various types of advertising media that can be employed to present advertisements to clients or consumers. Some examples of advertising media that can be represented by the playlist data files include linear television (TV) or radio, video on demand (VOD), internet protocol TV (IPTV), internet media, digital signage (e.g., still images or video), broadband video (e.g., wired and wireless—mobile TV), and interactive ETV. Moreover, for a given playlist, advertising media content can be presented in conjunction with associated program content (e.g., a primary media asset) or the advertising media can be presented in the absence of any associated program content. In situations when advertising media identified in a playlist data file is presented in conjunction with a primary media asset, the advertisements can be presented as the same or as a different type of media element from the primary media asset. For the example of linear TV, an advertisement defined in a playlist data file can correspond to a video media element that a playout device streams to the end user(s) in place of the primary media asset or, alternatively, it might correspond to an image or video media element that is overlayed (e.g., as a banner ad) onto the primary media asset (a broadcast video). A given playlist for a given playout device further can identify advertisements that include more than one type of media element that a corresponding playout device can present to the consumers.

As will be appreciated by those skilled in the art, portions of the invention may be embodied as a method, data processing system, or computer program product. Accordingly, these portions of the present invention may take the form of an entirely hardware embodiment, an entirely software embodiment, or an embodiment combining software and hardware. Furthermore, portions of the invention may be a computer program product on a computer-usable storage medium having computer readable program code on the medium. Any suitable computer-readable medium may be utilized including, but not limited to, static and dynamic storage devices, hard disks, optical storage devices, and magnetic storage devices.

Certain embodiments of the invention are described herein with reference to flowchart illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits) to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

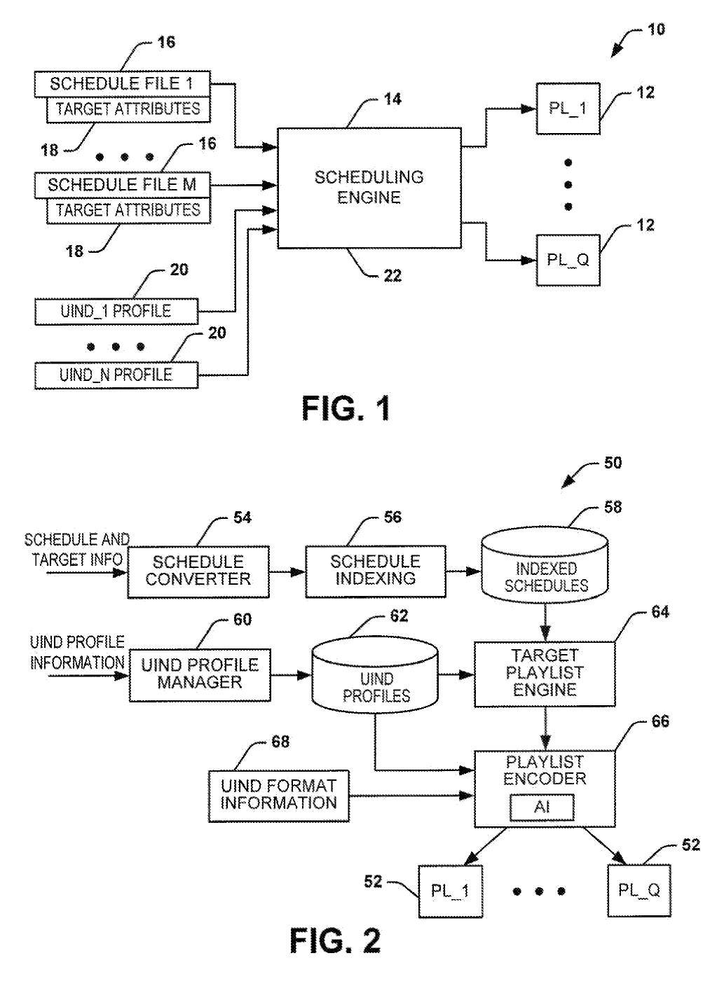

FIG. 1 depicts an example of a system 10 that can be utilized for generating a plurality of playlists 12 according to an aspect of the invention. In the example of FIG. 1, the playlists are represented as playlist PL_1 to PL_Q, where Q is a positive integer denoting the number of playlists that are generated. As described herein, the playlists 12 facilitate the distribution targeted advertisements by a plurality of downstream playout devices. As used herein, each downstream playout device can be implemented as a uniquely identifiable network device (UIND), which for the example of FIG. 1 there are assumed to be N UINDs, where N is a positive integer. The configuration and operation of a given UIND, for example, can vary according to the type of media or mode through which the media content is being distributed.

For example, for linear program content, such as linear TV or radio, the UIND can be implemented as including a splicer or mixer in a playout device that distributes or streams the linear program content to the end users or clients. For the example of a mobile UIND, such as a cellular telephone or other mobile appliance, the head end or cellular base station can correspond to the UIND. In other examples, the end user itself can be the UIND when such device is uniquely identifiable in the network, although in the examples described herein the UIND is located upstream from the end user and is configured to present one or more types of media to a plurality of end users.

The system 10 includes a scheduling engine 14 that is programmed and/or configured to generate the targeted playlists 12 based on analysis of target attributes 18 associated with each of a plurality of input schedule files 16 as well as profile data 20 for the plurality of UINDs. The scheduling engine 14 receives a plurality of schedule files 16, indicated at SCHEDULE FILE_1 through SCHEDULE FILE_M, where M is a positive integer denoting the number of input schedule files. For example, a plurality of M schedule files 16 can be created by associated traffic and billing system for a given program or a given sequence of plural programs. The content and format of each of the schedule files 16 can vary depending upon the traffic and billing system utilized to create each respective schedule file as well as the type of media for which the schedule has been created (e.g., linear TV, VOD, digital signage, internet, broadband video and the like).

For the example of linear television, each of the schedule files 16 can include the time of a given program (e.g., a primary media asset), the duration of the program, the avail and break information as well as an identification of specific advertising spots scheduled in each of the respective breaks. For the example of digital signage, the schedule file 16 may a sequence of media elements, an identification of the duration and timing for each of the media elements. In digital signage, the schedule file may also include a copy of each media element (e.g., image or video data) that is presented at the scheduled times. Alternatively for digital signage and for other types of media, a schedule file 16 may contain an identifier to uniquely identify the respective advertising media asset (e.g., including its location in the network and its name) that is to be presented at the scheduled breaks.

Each of the respective schedules 16 demonstrated in the example of FIG. 1, while providing timing and break information for the same program, may include (or identify) a different set of advertising media assets. That is each schedule can include a set of one or more advertisements determined to be pertinent to a particular segment of the population; namely, the intended target audience. Thus, for the example of linear television, each of the schedules can be created (e.g., via existing traffic and billing systems) to provide different sets of ads in each schedule according to the intended targets of the programming in the respective schedule files.

A set of attributes or characteristics of the intended target audience for a given schedule 16 is defined by the target attribute data 18. For instance, the target attribute data 18 can include variables or parameters that represent demographic information, (e.g., demographic variables, such as gender, race, age, income range, religion, disabilities, mobility (in terms of travel time to work or number of vehicles available), educational attainment, home ownership, employment status), geographic location, the type of media, consumer behavior and the like. Those skilled in the art will appreciate various types of information that can be included in the target attribute data 18 to identify different market segments and appropriate targeted advertisements for each schedule.

As one example, target attribute data 18 can be provided as metadata associated with each of the schedule files 16. The target attribute data 18 can be part of the schedule file 16 when the schedule file is created or be subsequently uploaded and linked with the schedule file where the attribute data do not form part of the schedule file itself. The scheduling engine 14 can be programmed to index the parameters contained in target attribute data with each of the respective schedules 16. The indexing of the schedule file 16 and respective target attributes 18 can be implemented by the scheduling engine 14 as part of an ingest process in which the schedule file 16 and corresponding target attribute parameters of the data 18 are sorted, formatted and stored in a database or other data structure. By indexing the schedules 16 by target attribute parameters, the target attributes are readily available as information to analyze relative to the UIND profile data 20 for constructing the playlists 12.

Additionally, or alternatively, the target attribute data 18 can identify one or more of a plurality of preconceived demographic profiles for a given group or segment of the population. For example, the target attribute data 18 can identify a target audience as belonging to the “baby boom generation”, “generation-X”, a young urban profession (or yuppie) to name a few. Alternatively, a demographic profile might include attributes sufficient to identify a particular segment or subgroup of the population (e.g., people who are single, female, middle-class, age 18 to 24). Such a categorization of different population or market segments can be provided as the target attribute data 18 or, alternatively, such a generalization can be determined by the scheduling engine 14 based on analysis of the set of target attribute parameters that have been associated with a given schedule.

As a further example, target attribute parameters can be processed by the scheduling engine 14 or by other associated software to define a category of attribute of the intended target audience for each schedule. For example, the indexing and sorting performed by the scheduling engine 14 can identify a given schedule as being targeted for a specific demographic in which the schedule includes or identifies ads that have been customized or targeted for such demographic. Alternatively, the indexing and sorting performed by the scheduling engine 14 can identify a given schedule as being targeted for a zone or region in which the schedule includes a set of one or more ads intended for a given zone or region. Still a further alternative would be to have personalized schedules customized for each end user based on attributes or profiles for each user. However, it is likely that each end user or playout device fits into a predefined category or market segment that can be identified and be targeted as an aggregate group by a given playlist that is generated by the scheduling engine 14. It will be appreciated by those skilled in the art that the granularity of the schedule files 16 (e.g., the number of media elements) and the number and types of the intended target audiences (as defined by target attribute data 18) can be selected according to application requirements based on the teachings contained herein.

As mentioned above, the scheduling engine 14 also receives the UIND profile data 20 for each of a plurality of uniquely identified network devices UNID_1 profile through UNID_N. For example, the profile data 20 for a given UIND can include information that characterizes the group or of one or more consumers to which the UIND presents its content. As one example, the profile data 20 can include demographic, such as described above, as well as other information that can be utilized to describe or characterize the audience of the UIND. Such information further can include geographic or location information, such as may be represented by postal zip code, telephone area code or other known parameters for a given region or zone. The profile data can be provided in various data formats (e.g., as an XML document, an HTML document), which can be converted by the scheduling engine 14 or other associated conversion software into a form useable by the scheduling engine. Alternatively, the profile can be constructed according to a data model, such as a Resource Description Format (RDF) based model, which may expressed in XML or other syntax. The type and format of the information can vary according to the source of such information.

Those skilled in the art will understand and appreciate various sources that can provide the profile data 20 for a given UIND or a set of UINDs. The UIND profile data can be provided from the UIND itself, by an entity or service that controls the UIND and/or from one or more external information provider (public or private) that has determined attributes for the audience of the UIND or a group of UINDs. The type and source of profile data can vary according to the type of media that the UIND presents and the number of end users serviced by the UIND. For example, where the UIND corresponds to a mobile telephone, the profile information can be obtained (with appropriate permission) from the mobile carrier or the owner of the mobile telephone. For digital signage, the owner of the digital sign may obtain information from surveys as well as other geographic and demographic information for the location in which the sign is placed or by the expected persons that may pass by the digital sign. For the internet, various modes of tracking a given users internet activity, including cookies, can be utilized to collect information that can be further processed to generate the profile data 20. In the case of linear television, information about the viewing audience for a given UIND can be provided by the operator of the UIND based on information that the operator has obtained for a given region or directly from the viewers serviced by the given UIND. As another example, the profile data for UINDs in gambling venues, which can present content any of a variety of media types, can be acquired from player cards as well as demographic information that may be obtained by the gambling establishment itself.

The scheduling engine 14 is programmed and/or configured to rationalize the target attribute data 18 for the schedule files 16 with the UIND profile data 20 to generate the respective playlists 12. This rationalization can include the scheduling engine comparing each set of UIND profile data and the target attribute data 18 to identify which target attribute data best matches each set of profile data. The scheduling engine 14 in turn identifies a given schedule for each of the UINDs and generates a corresponding playlist 12. Thus, each of the playlists 12 can be provided to one or more respective UIND based upon the rationalization performed by the scheduler engine 14. Those skilled in the art will understand and appreciate various algorithms and processing techniques that can be utilized to intelligently match UIND profiles (defined by the profile data 20) with the targeted schedules 16, as indexed by the scheduling engine 14.

By way of example, the scheduling engine 14 can employ artificial intelligence, such as an artificial neural network, Bayesian rules, fussy logic or the like to intelligently match target attribute data associated with a given schedule file 16 with the parameters in each set of UIND profile data 20. For instance, an artificial neural network can be trained (e.g., based on empirical data) to recognize patterns in one or both the profile data and the target attribute and to identify a predefined category corresponding to the recognized pattern. For instance, the predefined category can be selected from a set of different demographic profiles, geographic profiles, other consumer attributes or any combination of attributes. When two patterns substantially match each other (e.g., within predefined limits), the associated schedule is assigned to the UIND and a corresponding playlist is generated. It is to be understood that one or more types of artificial intelligence can be programmed into the scheduling engine 14 to perform the rationalization. The enhanced functional intelligent aspects of the scheduling engine 14 can be implemented by means of software programming of a simple microcomputer, or by use of more specialized processors, such as a Fuzzy Set Processor (FSP) or Neural Network Processor to facilitate the rationalization between the target attribute data and the UIND profile data.

As one example, each of the playlists data files 12 can include information, such as including a destination or network address, which identifies each UIND to which each respective playlist is to be routed. The playlists generator 22 further can generate each of the respective playlists 12 in a format (e.g., following a predefined schema) according to the input requirements of the UIND for which each respective playlist has been generated. For instance, the same schedule can be sent to different UINDs in different respective playlists, each encoded according to different formats. As another alternative, the scheduling engine 14 can generate each of the playlists according to a common predefined schema, which can be converted to a format to enable consumption by each UIND. Various known tools exist that can be utilized to convert the respective formats which can be utilized by the playlist generator or downstream by the UIND to which the respective playlist is routed. For instance, the conversion to a particular format or schema for a given UIND can be performed upstream by the playlist generator 22 or downstream by the UIND itself or by a component in the system that is accessible to the scheduler engine 14 or the UIND.

FIG. 2 depicts an example of a system 50 that can be utilized to generate a plurality of targeted playlists 52 according to an aspect of the invention. The system 50 includes a schedule converter 54 that receives schedule and target information. The schedule and target information can include a plurality of schedule files in one or more formats, such as can be generated by traffic and billing software. As described herein, the information in each schedule file can vary according to the type of media for which the schedule has been created. For the example of linear broadcast and VOD programming, a schedule file can encode the advertising media content and timing information for one or more primary media assets (e.g., a streamable show, movie or the like). Alternatively or additionally, a separate schedule file can be generated to provide respective scheduling parameters for each avail or break that is expected for a given program. In this way, a plurality of schedule files would be associated with the given program which, in aggregate, define the advertising media content and timing information that is to be presented throughout the given program. As used herein, an avail corresponds to an upcoming scheduled ad opportunity or break into which one or more ads can be provided. An avail can be encoded or embedded into a primary media asset, such as in the form of a digital cue and/or other identifier that can uniquely identify the avail.

As discussed with respect to FIG. 1, target attribute data can be associated with each respective schedule to identify attributes or otherwise characterize the target audience for the advertising media content identified in a given schedule file. The target attribute data may be provided as metadata with the given schedule or provided separately from the schedule file. The number of schedules can vary depending upon the granularity of a given schedule as well as the number of different intended target audiences for which a set of one or more ads may be desirable for a particular target attributes.

The schedule converter 54 is programmed to convert the schedule files and target attribute data into a format to facilitate subsequent processing. By employing the schedule converter 54, schedule data can be converted from any one of plurality of input formats, such as may vary according to traffic and billing software used to create the schedule file, to a predefined format of information useable by the system 50. The converted schedule files are provided to a scheduling indexing block 56.

The scheduling index block 56 generates a plurality of indexed schedules 58 in which the associated target attribute data has been utilized to index the respective schedules, such as described herein. Those skilled in the art will understand appreciate various types of data structures that can be utilized to store the indexed schedules (e.g., tables, linked lists, an RDF graph represented in an XML syntax and the like). As one example, the schedule indexing block 56 can be programmed to identify the target attributes for each respective schedule as belonging to a particular one of a plurality of predefined target categories (e.g., corresponding to different demographic profiles), such that each of the converted schedule files is indexed by one or more of such categories in the indexed schedules 58. Alternatively, the schedule indexing block can include a representation of the target attributes as the indexing feature of the indexed schedules 58.

The system 50 also includes a UIND profile manager 60 that is programmed and/or configured to generate UIND profiles 62 based on UIND profile information that may be provided to the system 50. As discussed above with respect to FIG. 1, the UIND profile information can be generated or provided from a variety of sources depending upon the type of UIND and the mode of media content presentation. The UIND profile manager 60, for example, sorts and arranges the profile information provided for each of the respective UINDs or related groups of UINDs. Such sorting further can characterize such profile information consistently into a known lexicon or ontology to facilitate further processing of the UIND profiles 62 relative to the indexed schedules 58. Additionally, in circumstances, where separate UINDs may have the same or similar profile information (e.g., serving the same or similar geographic region or demographic segment), a common profile can be provided for such UINDs.

A target playlist generator 64 rationalizes the indexed schedules 58 and the UIND profiles 62 to construct a set of playlists in which the target information has been correlated and matched relative to the UIND profiles 62. As described herein, the target playlist generator 64 can employ artificial intelligence (AI) 65 to match each of the UIND profiles 62 with corresponding indexed schedules. For example, the AI 65 can query the structure of indexed schedules 58 with each of the UIND profiles to determine which schedule is indexed by attributes that most closely matches each respective UIND profile. A playlist can be generated in response to this query, which playlist may include one or more schedules for each UIND. If the playlist is properly formatted for a UIND, such playlist may be propagated and stored as one of the playlists. In other situations, the playlist generated by the target playlist generator 64 may not be formatted for use by a recipient UIND. Accordingly, the system 50 can include a playlist encoder 66 that is programmed to encode each playlist that is generated into a proper format.

The playlist encoder 66 thus encodes or distills the constructed playlists to various supported formats for consumption by the UINDs to which the playlists are to be distributed. For example, the playlists encoder 66 receives UIND format information 68 that describes playlists format requirements for each of the UINDs such that the playlist encoder 66 can encode the playlist data into the appropriate formats. The formats can be standard schedule formats as well as include proprietary formats for a given UIND. The UIND format information 68 can be provided to the system 50 in conjunction with the UIND profile information 62. The playlist encoder 66 further can include a converter (not shown) for converting the constructed playlist into the appropriate formats. The playlist encoder can employ known conversion tools for appropriate format conversion, which tools may reside locally in the system 50 or tools that reside remotely (e.g., running on a remote server). Thus, the playlist encoder 66 generates the playlists 52 that define targeted advertising content and scheduling information that has been matched to the profile of a given UIND. The playlist 52 can include content, including advertising content, as well as program content that is to be presented by the UINDs. The particular type of information that will be included in each respective playlist 52 can vary depending on the type and configuration of the UIND and the type of media.

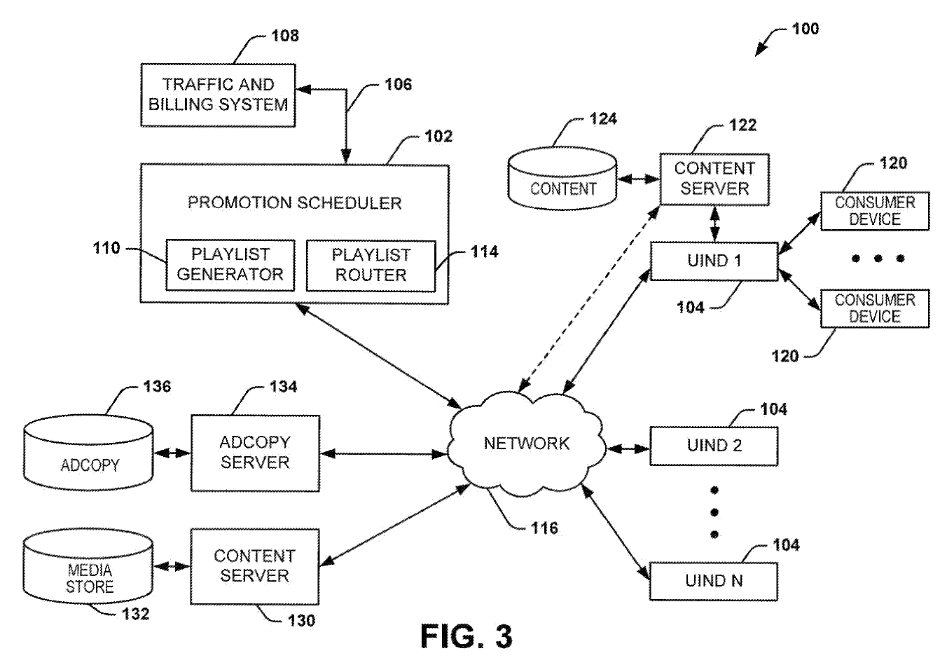

FIG. 3 depicts an example of a distribution system 100 that can be utilized to provide for targeted advertising according to an aspect of the invention. The system 100 includes a promotion scheduler 102 that is programmed to construct targeted playlists that can be sent downstream to one or more UINDs 104, indicated at UIND_1, UIND_2 through UIND_N, where N is a positive integer denoted in the number of UINDs in the system. In the example of FIG. 3, each UIND 104 can represent an individual or a group of playout devices that present media, including at least advertising media, such as may be perceived by one or more end users or consumers.

The promotion scheduler 102 receives schedule files, indicated schematically at 106, from a traffic and billing system 108. The traffic and billing system 108 includes a user interface and tools to facilitate creation of schedule files that define advertising content and how and when such content is to be presented. The particular structure and content of the schedule file can vary depending upon the type of media content and the scheduled mode or modes of presentation. The schedule files 106 can be uploaded from the traffic and billing system into the promotional scheduler 102. Target attributes are associated with each of the respective schedule files. Such target attributes can be included as part of the schedule files (e.g., as metadata) or the target attributes can be provided separate information that identifies characteristics of the intended target for a given schedule. In this way, the user can employ the traffic and billing system 108 to generate a plurality of schedules, each of which schedules includes a different set of targeted advertising content. Each schedule file can identify the advertising content for a complete program. Alternatively, at a more granular level, a schedule can identify advertising content for a pre-identified avail or break that may form part of (or be scheduled in) a given program. In this approach, a plurality of separate schedule may be utilized to define advertising content for a given program.

As a further example, the target information can be provided as metadata such as in XML document that identifies attributes of the intended target, such as may include demographic information (e.g., age, gender, income range) or geographic information and the like. The promotion scheduler 102 may also receive the target attribute data or other INPUT(s) via a user interface 110. Such other inputs may also include profile attributes associated with a set of one or more UINDs 104.

The promotion scheduler 102 includes a playlist generator 112 that can construct or craft playlists by rationalizing the intended target for each of the schedules relative to the UIND profile information. As described above with respect to FIGS. 1 and 2, the playlist generator 112 can pre-craft a set of unique playlists to facilitate targeted advertising in the system 100. The promotion scheduler 102 further includes a playlist router 114 that is programmed and/or configured to route each playlist to one or more corresponding UINDs 104.

As an example, the playlist generator 112 constructs a set of playlists. Each of the playlists is to be utilized by one or more UIND 104 based on which target attributes, which characterize the intended target audience for each schedule, best matches the profile characteristics for each UIND 104. As one example, the set of playlists constructed by the playlist generator 112 can include destination information (e.g., a unique network address) for distributing each playlist to one or more of the UINDs 104. Alternatively, the playlist router 114 can perform the rationalization of UIND profile information and target attributes. For instance, the playlist router 114 can determine which target attributes (e.g., as encoded in a given playlist) best matches the profile data provided for each of the UINDs 104. The router 114 thus in turn route each of the playlists to the UIND or a set of UINDs based on the rationalization performed by the router. In this way, selected pre-crafted playlists can be distributed to each of the UINDs 104. As described herein, the type of playlist and information contained in the playlist may vary according to the type of UIND and the type of media that can be presented thereby.

The promotion scheduler 102 is connected to a network 116 which may be a local area network (LAN), a wide area network (WAN), which further may include an intranet, the internet or a combination thereof. The network 116 further may include a physical connection (e.g., optical fiber or conductors) or a wireless connection or a combination of wireless and physical connection that interconnect various parts of the system 100. In the example of FIG. 3, each of the UINDs 104 is also coupled to communicate over the network 116.

UIND_1 is configured to present content to a plurality of consumer devices 120, such as may correspond to set top boxes, televisions or other consumer electronic devices, or mobile wireless devices to name a few. UIND_1 thus receives a playlist or a plurality of playlists from the promotional scheduler 102 via the network 116 and stores the playlist(s) in appropriate memory. The UIND_1 also receives content from a content server 122 that stores such content in associated memory 124. The associated memory 124, for example, can include one or more primary media asset (e.g., media program content) that is to be transmitted (e.g., streamed) by the UIND 104 to the consumer devices 120. The associated memory 124 may also store one or more advertising media asset (e.g., advertising content) that can be presented to the consumer devices 120 as defined in the playlist received from the promotional scheduler 102. Media content can be provided to the content server 122 via the network directly (indicated by dashed lines) or via the UIND_1 from the network 116.

In the network system 100, media content can also be provided to the UIND_1 or to any of the UINDs 104 by a content server 130 that stores such content from an associated media store 132. The content server 130 and the available content stored in the media store can be accessed by one or more of the UINDs 104 via the network 116. The content server 130 can thus stream data to the UINDs 104, which may include Moving Picture Expert Group (MPEG) data or data in other standard or proprietary data formats, as may be required, for presentation by the UINDs.

At times predefined by scheduling data in the respective playlists, each UIND 104 is programmed to present advertising media content. The advertising content can be stored locally in memory (not shown) at each UIND 104. Alternatively, advertising media data can be obtained by each UIND from an adcopy server 134. The adcopy server 134 can store the appropriate adcopy in a database or other storage media 136 that can be provided to the UINDs 104. The respective UINDs thus can provide such advertising media for presentation by one or more consumers, which can vary according to the type or types of media supported by each UIND. For instance, in the context of a linear TV media, the UIND can present such advertising media by splicing or insertion the advertising content into the streamed media content. Alternatively, the playlist may define a different type of advertising media that is scheduled to be presented by the UIND, such as including one or more of banner ads, overlays or interstitial media that is presented in combination with the primary media asset (e.g., linear programming).

The UIND_2 through the UIND_N can be the same or different types of network devices for presenting or distributing content downstream. Those skilled in the art will understand and appreciate various types of devices that can be utilized as UINDs, which further may vary depending upon the ultimate consumer to which the media is presented.

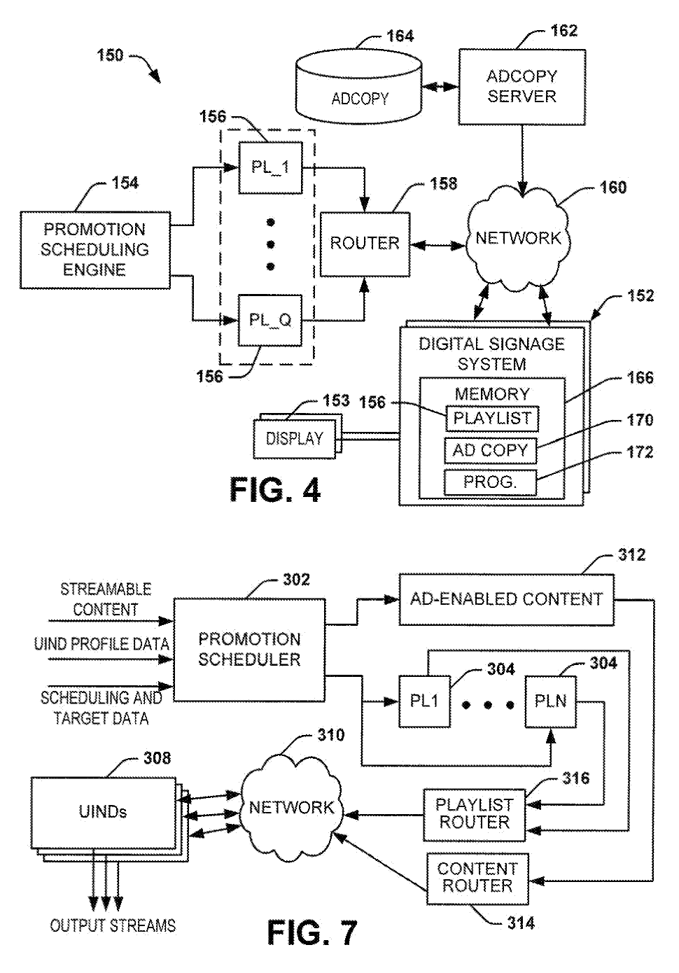

FIG. 4 depicts an example of a system that can be utilized to facilitate targeted advertising for a plurality of digital signage systems 152 according to an aspect of the invention. As used herein, a digital signage system corresponds to a UIND that can include a hardware and software programmed to deliver scheduled media content to one or more display devices 153. The media content can include various information, such as public service announcements, local weather information, and advertising media to name a few. There exist various types and configurations of display devices 153 including, for example LCD, plasma, CRT or other display device capable of displaying images or video thereon. Each digital signage system 152 can present media content to one or more of display devices 153.

Similar to the examples, described above, the system 150 includes a promotion scheduling engine 154 that is programmed and/or configured to generate a plurality of playlists 156, indicated at playlist 1 through Q, where Q is a positive integer denoting the number of playlists. As described herein, the promotion scheduling engine generates the playlists 156 to include scheduling information for one or more identified advertisements intended for a particular type of target audience that best matches corresponding profile characteristics for each of the digital signage systems 152.

For example, the promotion scheduling engine 154 ingests a plurality of schedules, each schedule including or identifying a set of one or more advertisements for display on a digital signage system. Intended target attribute information is also associated with each of the schedules. The promotion scheduling engine also receives profile information associated with each of the one or more digital signage systems 152 in the system 150. The promotional scheduling engine 154 is programmed to rationalize the profile information relative to the target information associated with the respective schedules to generate the targeted playlists 156 so that each playlist includes a set of advertising media that best matches the audience profile for each digital signage system.

A router 158 is programmed to distribute each of the respective playlists 156 to the appropriate digital signage systems 152 via a network 160. The network 160 can include both wired and wireless networks, such as configured in a LAN, WAN or a combination thereof. For example, each of the playlists 156 can include one or more destination addresses identifying each destination digital signage system to which the respective playlists is to be routed. Alternatively, profile information can be embedded into the playlist 156 such that artificial intelligence (e.g., running in the router 158 or in some other accessible computing apparatus) can identify an appropriate destination for each of the respective playlist 156. In such a situation, the router will employ the profile information to determine the destination address for each of the respective playlists 156. In such situation, it is plausible that a given playlist may have no destination in the system and, therefore, may not be routed. As the profile information might change over a period of time, such as due to changes in demographics for a given geographic location, updates to the profiles can result in redistribution or rerouting of the playlist to the digital signage system. Alternatively, playlists can be updated periodically based on such changes and routed to the appropriate digital signage systems 152.

In addition to including a targeted schedule, each of the playlists 156 can also includes a set of one or more advertising media asset (e.g., adcopy 170) that is to be displayed according to the scheduling and timing information provided in the playlists 156. The adcopy 170 can be routed as advertising media data to the digital signage system 152 with the playlist 156. Alternatively, the system 150 can include one or more adcopy servers 162 and an associated adcopy storage 164 in which appropriate adcopy (e.g., images or videos) are stored. A given digital signage system 152 thus can retrieve appropriate adcopy through the network 160 from the adcopy server 162 based on unique identifiers provided in the targeted playlist 156 that has been routed to the given digital signage system.

The digital signage system 152 can also include memory 166 that locally can store the playlist 156, the adcopy 170 as well as other program instructions 172. The program instructions 172 can control various functions of the digital signage system 152, as is known in the art. The program instructions 172 can be programmed through the network 160 from another programming station. Alternatively the program instructions 172 can be loaded into the memory 166 as part of the installation of the digital signage system 152. It is to be understood that data and program instructions can be loaded into the memory 166 either remotely via the network 160 or locally being an appropriate user interface device (not shown) coupled to the digital signage system.

The playlists 156 in the memory 166 can include one or more of the playlists 156 generated by the promotion scheduling engine 154. The playlists 156 in the memory 166 further can include an identification of the adcopy that is displayed, the amount of time or duration that a given advertising media asset or other information is to be played. Because, for certain types of digital signage, the audience may vary by day of the week, by time of day or by any combination of time-based scheduling criteria, the playlist can selectively schedule different sets of advertising media to be displayed for an intended target audience by employing such time-based scheduling criteria.

As an example, for a digital signage implemented as including an electronic billboard located along a highway in a given geographic region, the playlist can include scheduling times for ads targeted for commuter traffic that typically occurs during normal rush hour traffic time periods for Monday through Friday. During the day, in which traffic has a priori been determined to correspond to different market segment, a second set of targeted ads may be defined in the playlist data 156 that is stored in the memory 166 and intended to reach this market segment for the given geographic area. Additionally, evening hours further can be targeted towards another market segment of consumers that may pass by the display device 153. Similar sets of customized and targeted scheduling can be produced by the promotion scheduling engine 154 for weekends or other pertinent time periods.

Those skilled in the art will appreciate various algorithms and methods that can be utilized to schedule targeted playlists that can be distributed to that the digital signage system based on the teachings contained herein. Additionally, it is to be understood that the playlist for given digital signal system (or a group of digital signage systems) further may be customized based upon local events or activities that may be occurring for the particular geographical region (e.g., sporting events, concerts and the likes). Additionally or alternatively, the playlists for a group of digital signage systems can be coordinated to achieve a desired aggregate market impact. The particular types of events and activities for a given geographic region associated with a digital signage system can be provided to the promotional scheduling engine as the profile data based on which the playlists are generated.

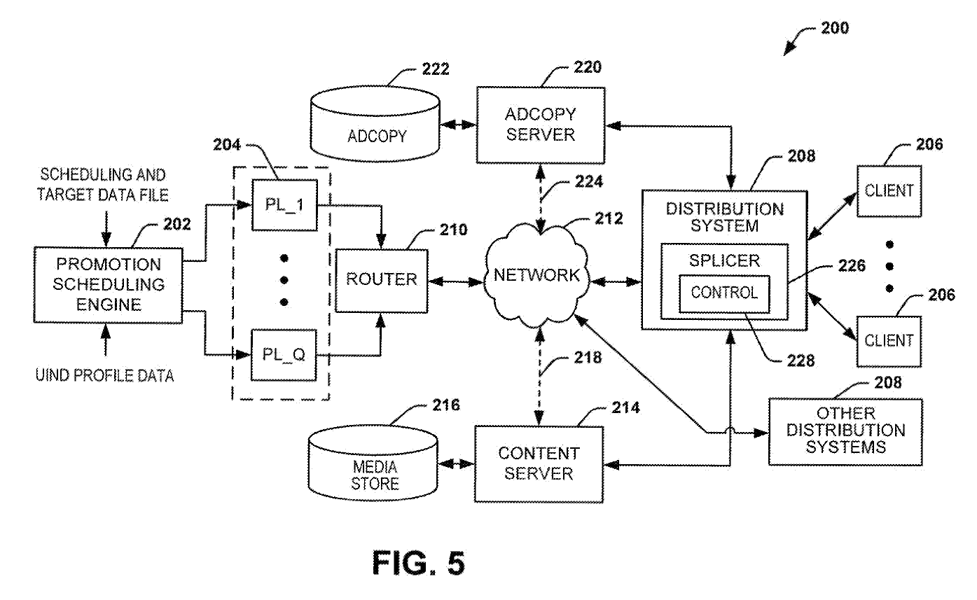

FIG. 5 depicts an example of a system 200 to facilitate targeted advertising for streamable media, such as a linear television or video on-demand (VOD) system. Similar to the other types of media or modes of media presentation, the system 200 includes a promotion scheduling engine 202 that is programmed and/or configured to construct a plurality of playlists 204. The promotion scheduling engine 202 generates the respective playlists 204 by rationalizing scheduling data files and associated target data relative to profile data associated with each of a plurality of UINDs, which in the example of FIG. 5 are demonstrated as distribution systems 208. Each distribution system 208 is programmed and configured to provide media content to a plurality of end users or clients 206, such as in the form of streaming media, based on the targeted scheduling information contained in a given playlist or a set of playlists that are sent to each distribution system 208. The distribution system 208 can correspond to a cable head end, a satellite provider, an internet service provider or other provider of such linear media content. The media content can include primary media assets (e.g., audio and video programming) and advertising media assets (e.g., adcopy).

In the example system 200 of FIG. 5, the profile data that is provided to the promotion scheduling engine for each distribution system 208 can include data or information that describes traits or attributes of the population segment that encompasses the set of one or more clients 206 to which the distribution system provides media content. As described herein, the profile data can include demographics, geographical or other information that can be utilized to define or characterize a market segment. Such profile data can be collected by the distribution system itself, the owner of the distribution system as well as may be obtained from other commercially available or proprietary sources. Such information may be aggregated and/or categorized to form the profile data.

An advertiser or advertising agency or other entity can create a schedule, such as by using traffic and billing system for the media type to provide a corresponding schedule file. The schedule file, for example, can include data that identifies one or more primary media asset (e.g., streamable program content), the time the content is to be played, avail and break information and an identification of which advertising media asset(s) are to be played at each respective break. Each of the breaks can also be identified by a break identifier, a time when the break is to occur as and the duration of the break. Other information further can be provided with the scheduled data based on schedule requirements and the traffic and billing software utilized to generate the scheduling data. As described herein, target data can be associated with each of these scheduling data files. For example, the target data can identify an intended target audience (e.g., a market segment or category) as well as include attributes of the intended target audience for the programming and adcopy that is identified in the schedule. The target data may be provided as metadata with the scheduling data or, alternatively, the target data can be provided subsequently or separately from the scheduling data. In this way, a user can generate a plurality of schedule files. Each of the schedule files can include different advertising media that can vary depending on the intended target audience, which can be defined by the target data that is associated with the respective schedule files.

As one example, for linear television, assume that a creator of the scheduling data determines there are four geographical areas to be identified as different market segments. In this scenario, four separate schedule files can be generated (e.g., via traffic and billing system) for the same program, but each schedule file includes different adcopy. It will be appreciated that the different adcopy does require no common advertising media, but instead means that there is one or more difference in the advertising media identified in the schedule. Each of the schedule files has associated target data that defines attributes of the four geographical areas. The promotion scheduling engine 202 thus can generate one or more targeted playlist 204 based on rationalizing the target data with profile data for the distribution systems 208 in the system 200. Each playlist can include routing data that identifies to which distribution system 208 each playlist is to be sent. The router 210 then can dispatch each of the playlists 204 to the appropriate distribution systems 208. As described herein, the approach described herein does not require that each schedule file be converted into a corresponding playlist, but instead helps to ensure that the schedule containing the most relevant advertising content is sent as a playlist to each respective distribution system. The router 210 can dispatch a given targeted playlist 204 to the distribution system 208 in advance of streaming the scheduled programming content and adcopy to the clients. It is to be understood that the approach described herein is not limited to example of geographical areas to define market segments. Other criteria can be utilized separately or in combination with geographical area to establish intended target audiences and corresponding schedule files.

Each distribution system 208 can receive the streamable content from an associated content server 214 that maintains one or more primary media assets (e.g., programming) in a media store 216. Alternatively, the distribution system 208 can receive live streaming content from another source, such as via the network 212 or via satellite or another suitable source. Those skilled in the art will understand appreciate various structures and architectures for content server 214 and the media store 216. The distribution system 208 can directly communicate with the content server (e.g., locally) or the distribution system may communicate with the content server indirectly, such as to obtain the streamable content through the network 212 (indicated by the dashed line 218).

Similarly, each distribution system 208 can obtain advertising media assets (adcopy) that are to be injected into the streamable content per the scheduling data and other information provided in the playlist 204 that has been distributed to the distribution system. For instance, an adcopy server 220 can provide selected adcopy ads to the distribution system 208 based upon the available advertising media assets stored in the adcopy storage 222. The distribution system 208 can directly communicate with the adcopy server (e.g., locally) or the distribution system may communicate with the content server via the network 212 (indicated by dashed line 224). As an example, if an identified adcopy is unavailable, the schedule may identify one or more alternative ads that can be substituted into a given break. While the adcopy server 220 and content server 214 are depicted in FIG. 5 as being separate structures, it is to be understood and appreciated that a single server or a plurality of two or more servers can be utilized to provide the streamable content to the distribution system 208.

Each distribution system 208 includes a splicer 226. The splicer 226 is programmed and/or configured to inject adcopy into the appropriate spots in the streamable content, as defined by the targeted playlist that is distributed to the distribution system. The splicer 226 thus includes a control component 228 that detects avails and breaks, such as based upon a cue or other identifying data embedded in the streamable content. In response to detecting such cue for a given break, the control component 228 employs the targeted playlist stored locally in the distribution system 208 to identify and retrieve the advertising media asset or assets have been scheduled for the respective break. The splicer 226 injects the retrieved advertising media assets as adcopy into the streamable media that is sent downstream to the clients 206. The adcopy can be in the form of one or more of traditional video, overlays, interstitials or banner ads, as defined by the scheduling data in the playlist. Additionally, it is to be appreciated that the advertising media assets in the context of FIG. 5 can be extended to include other information, such as weather, emergency information, political announcements, amber alerts and the like, which may be stored or live information.

Additionally or alternatively, prior to injecting the adcopy into the streamable media for distribution to the clients, the control component 228 can send a request to the promotion scheduling engine through the network 214 to request an updated playlist. For example, an avail can be provided in the streamable content to signal an upcoming scheduled break, which avail can be utilized to trigger the request for the updated playlist. In response to receiving the request, the promotion scheduling engine 202 (or other upstream apparatus) can send an updated playlist (if one exists) back to the distribution system so that a more up-to-date set of targeted ads can be inserted at a given scheduled break. In addition to changing which ad or ads are to be presented in a respective break, the update further can include different times an indication to skip a particular scheduled break or any other combination of ads and breaks that may be adjusted for distribution to the clients 206. Such an update can be requested for each of the scheduled breaks or an updated playlist may be requested and received at the beginning of a given program. The particular timing at which the request for update is provided upstream can vary depending upon the application requirements.

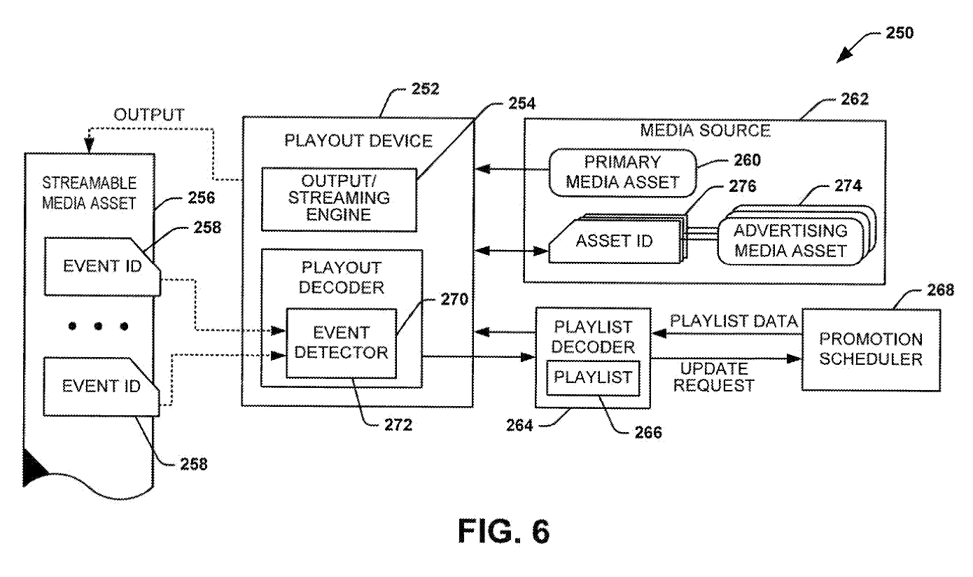

FIG. 6 depicts an example of a functional block diagram that demonstrates utilization of a targeted playlist in the context of linear television. In FIG. 6, the distribution system includes a playout device 252 that provides as an output a streamable media asset 254. The streamable media asset 254 includes streamable media content such as a linear television program (e.g., television program, movie or the like) corresponding to a primary media asset 260 provided by a media source 262, which can be in the form of a stored media program or a live broadcast. A plurality of event IDs 258 are embedded or encoded into the streamable media asset 256. Each of the event IDs 258 can, for example, correspond to a cue or other identifier corresponding to an avail for signaling an upcoming opportunity for a break. For the example of a cable network, the event ID 258 can be provided in accordance with the Society of Cable and Telecommunications Engineers (SCTE) protocol SCTE 35 entitled “Digital Program Insertion Cueing Message for Cable.” Those skilled in the art will appreciate other known or proprietary protocols that can be utilized to signal an upcoming break, which may vary depending on the type of media and method of distribution.

The playout device 252 includes an output or streaming engine 254 that is programmed and/or configured to output the streamable media asset that can be received by one or more clients or users downstream. The output streaming engine 254 thus can be coupled to the network or other infrastructure for transmitting the streamable media in the desired format, which may be an analog or digital signal. The particular format and the use of encryption can vary depending upon the type of media being streamed and the application requirements implemented in the system performing the streaming of the media. The output streaming engine 254 further can include a splicer that is programmed and configured to insert advertising media assets (adcopy) or other information into the streamable media asset 256. As one example, the output streaming engine 254 may comprise a Digital Turnaround Processor (DTP), which is commercially available from Harris Corporation of Melbourne, Fla.

The playout device 252 can receive the primary media asset 260 as digital data from a media source 262. The primary media asset 260 can be stored in a variety of formats or be provided as live streaming data. The playout device 252 queues the primary media asset or at least a substantial portion thereof into local memory (not shown) for output streaming via the output/streaming engine 254. The timing of the streaming is coordinated and synchronized relative to the scheduled information contained in the targeted playlist that has been provided to the system 250. For example, the distribution system 250 includes a playlist decoder 264 that receives the playlist 266 from an upstream promotion scheduler 268. For example, the promotion scheduler 268 can route the targeted playlist data to the distribution system 250 via an associated network or other communication infrastructure, which is schematically indicated as the playlist data in the example of FIG. 6. The playlist decoder 264 loads the received playlist 266 into associated memory. The playlist can include a schedule that defines a root level or container that can be divided into sub-containers (or sub-levels). For example, each sub-container can identify a set of media assets (including both primary and advertising media assets) as well as the scheduling details (e.g., timing and sequencing information) for such media assets.

As described above, the output streaming engine 254 outputs the streamable media asset in a particular format (e.g., in one of the MPEG standards) which includes the event IDs embedded therein. The playout device 252 (or other hardware and software operating within the distribution system 250) includes a playout decoder 270 programmed and configured to monitor and decode digital data embedded in the streamable media asset that is output by the playout device 252. The playout decoder 270 includes an event detector 272 that is programmed and/or configured to detect the embedded event IDs 280 in the streamable media asset 256. In response to the event detector 272 discovering an event ID, the playout decoder, via the event detector 272, informs the playlist decoder 264 of the detected event. The playlist decoder 264 can search the playlist data 266 to determine whether the detected event ID matches an event ID in the stored playlist data 266.

In response to detecting a match, the playlist decoder 264 instructs the playout device 252 to output the advertising media asset or assets corresponding to the detected event ID. Such instruction can identify one or more advertising media assets 274 (e.g., by unique asset identifiers) as well as the scheduling information that defines how such assets are to be presented. For instance, the output streaming engine 254 can inject the identified advertising media assets 274 into the output streamable media asset 256 based on instructions that define the order, timing, format and other pertinent scheduling information. In response to such instructions, the output streaming engine 254 can pause the streaming of the primary media asset 260 and inject each of the identified the advertising media assets as a substitute stream to be output as content to the viewer. When the advertising media asset or assets 274 intended to be associated with the current event ID are completed, the output streaming engine 254 can resume play and streaming of the primary media asset 260 until the next event ID is detected by the event detector 272. Thus, in response to detecting the next event ID 258 the event detector provides the event ID to the playlist decoder which in turn instructs the playout device 252 to play the corresponding advertising media asset or a plurality of assets associated with the event ID. This process can continue throughout the playout of the primary media asset or a series of primary media assets.

In one alternative example, the playlist decoder 264, in response to the event detector 272 discovering an event ID in the streamable media asset 256, can present an update request to the promotion scheduler 268. The promotion scheduler 268 can provide a corresponding response to the updated request. The response can include an updated playlist (PLAYLIST DATA) or a negative acknowledgement indicating no updated playlist exists. The playlist decoder 264 can decode the playlist data and store it locally as the playlist 266. The playlist decoder 264 can in turn query or search the playlist 266 to determine if the detected event ID 258 matches the available event IDs associated with a given media asset. For example, each advertising media asset (or a set of plural media assets) 274 can be assigned a respective asset ID 276.

The playlist decoder 264 can include a list that identifies each particular asset ID that is to be associated with each event ID for each scheduled current primary media asset. If a detected event ID 258 is determined to match a given asset ID 276, the corresponding advertising media asset 274 can be provided to the playout device 252 for injection into the output stream corresponding to the streamable media asset 256. In a situation where there is no match between the event ID and an asset ID 276, the system 250 can continue streaming the primary media asset 260 as the output streamable media asset is provided without interruption to the clients. Alternatively, one or more default advertising media assets can be injected into the output stream if no match exists.

FIG. 7 depicts another example of a system 300 for providing targeted advertising that can be implemented according to an aspect of the invention. The system 300 is similar in structure and function to the various approaches described herein. Briefly stated, a promotion scheduler 302 is programmed and configured to generate a plurality of targeted playlists 304 based on rationalizing schedule data files and associated target data relative to UIND profile data. The resulting playlists 304 are encoded to identify (and/or include) advertising media specially pre-crafted for a known target audience. Each of the playlists is provided in a format and syntax for consumption by one or more of a plurality of UINDs 308. Each playlist also can uniquely identify each advertising media asset or a predetermined group of media assets by an advertising identifier (an AD_ID).

In addition to the scheduler 302 generating the plurality of pre-crafted playlists 304 that can be distributed selectively to UINDs 308 throughout a network 310 to provide for the targeted advertising, the scheduler also generates ad-enabled content 312. The ad-enabled content 312 for a given program (e.g., a media asset) is encoded with predetermined event identifiers that correspond and can be the same as advertising identifiers utilized in the playlists 304. Alternatively, the ad-enabled program can correspond to a given portion of a program or a plurality of programs.

The one-to-one correspondence between the advertising media identified in the playlist and event identifiers in the ad-enabled content facilitates the processing required to inject advertising media into each break for an output media stream. Additionally, the use of common event identifiers in both the ad-enabled program content and in the playlists further enables enhanced control of media presented by each of the UINDs. For instance, the UIND can also be programmed to selectively control whether to insert any adcopy in a break or to select different amounts or types of advertising to be inserted into a primary media asset. The selection and control of adcopy insertion, for example, can be based on the cost a subscriber pays for a given program (e.g., the cost of an individual program or monthly subscription).

The ad-enabled content 312 can be provided to a plurality of UINDs 308, such as playout devices or other distribution systems. Each of the UNIDs 308 can inject unique sets of targeted advertising into the ad enabled content 312. For example, the system 300 can include a content router 314 that routes the ad-enabled content to the UINDs or to one or more media servers from which the UINDs can acquire the ad-enabled media assets. The system also includes a playlist router 316 to route the playlists to the appropriate UINDs 308. While the routers 314 and 316 are depicted as separate routers, a single router or other apparatus may be utilized for routing the playlists 304 and ad-enabled content 312.

It will be appreciated that in the approach of FIG. 7, in addition to constructing playlists for scheduling targeted advertisements for each of a plurality of pre-identified target audiences, the scheduler 302 also generates the ad-enabled media content encoded with predetermined event identifiers. These predetermined event identifiers can be detected as place markers or cues for injecting the targeted advertising defined by each respective playlist. It is also to be understood and appreciated that each scheduled advertisement that is to be injected or inserted into the ad-enabled content need not be the same type of advertisement. For example, certain of the event identifiers can be utilized to identify a linear advertising that can be streamed to a user whereas other event identifiers may identify banner ads, URLs, or other rich media that can be injected into or overlying the primary media asset defined by the ad-enabled content. Thus, as in the other examples described herein, the advertising media that is to be inserted or played can be decoupled from the other media program into which they are injected. This decoupling further permits scheduled breaks to be of variable length, since the primary media program can automatically resume after the injected advertising media has been completed for a given break.

As described herein, each targeted playlist can be pre-crafted by a promotion scheduler and provided in a format and syntax according to the application requirements and capabilities of the downstream UIND to which each respective playlist is routed. The following TABLE 1 is an example of node types that can be supported in when using an XML playlist to exchange sequencing and scheduling information in a playlist data structure constructed according to an aspect of the invention. The names of the nodes are intended to be informative, and do not necessarily represent actual implementation details as may be found as the xml node entity in the file itself. The actual syntax of the items below further can vary depending on the formats required by the playout device and the capabilities of that device.

TABLE 1

| | |
|---|---|
| contractData | Information as a series of name/value pairs that help |
| | describe the content be sent to the promotion scheduler |
| mediaasset | Denotes a media asset item, and where it can be found. |
| | Assets may range from MPEG files, to JPEG images, |
| | depending on the capabilities of the playout device. |
| interruptlevel | Denotes the interrupt rule to be applied to the media |
| | asset items within an “exclusive” container |
| sequence | Denotes a time box that ensures the media assets |
| | described within it will play in the order in which they |
| | exist in the list. |
| root | Denotes the root element of the XML file |
| exclusive | Denotes a media container in which only a single |
| | media asset will be played at a time. The order of |
| | the media assets within the “exclusive” element |
| | are played out is not restricted |
| alternateloc | Allows the system to find other assets or search additional |
| | locations if the originally specified item is unable |
| | to be found |

The following TABLE 2 is an example of possible XML attributes that can be utilized to help control how a given media asset will be played out on a UIND.

TABLE 2

| XML attribute | Description |
|---|---|
| begin | The time at which an element becomes active, relative to the |
| | start of its parent time container. |
| clipBegin | The time at which a stream begins playing, relative to the start of the |
| | stream. |
| clipEnd | The time at which a stream stops playing, relative to the start of |
| | the stream. |
| dur | The simple duration of a media element. |
| end | The time at which a media element stops playing, relative to the start |
| | of its parent time container. |
| endSync | The synchronization rule for child media elements within a |
| | parent time container. |
| syncEvent | Describes what event should be listened for to activate the given |
| | media asset |
| higher | Controls how media elements from a higher interruptlevel |
| | element interrupt the media elements in the active interruptlevel element. |
| id | Uniquely identifies an element. This value must begin with a |
| | letter. |
| lower | Controls how media elements from a lower interruptlevel |
| | element interrupt the media elements in the active interruptlevel |
| | element. |
| mediaName | A name for an entry in a playlist. |
| noRecede | Whether a client can skip to the previous element in the playlist. |
| noSkip | Whether a client can fast forward, rewind, seek, or skip next |
| | within the current media element. |
| peers | Controls how media elements within an interruptlevel element |
| | interrupt one another. |
| repeatCount | The number of times that an element is repeated. |
| repeatDur | The total duration of a repeated element. |
| role | The type or purpose of a media element. |
| src | The location (e.g., URL) for a media element. |

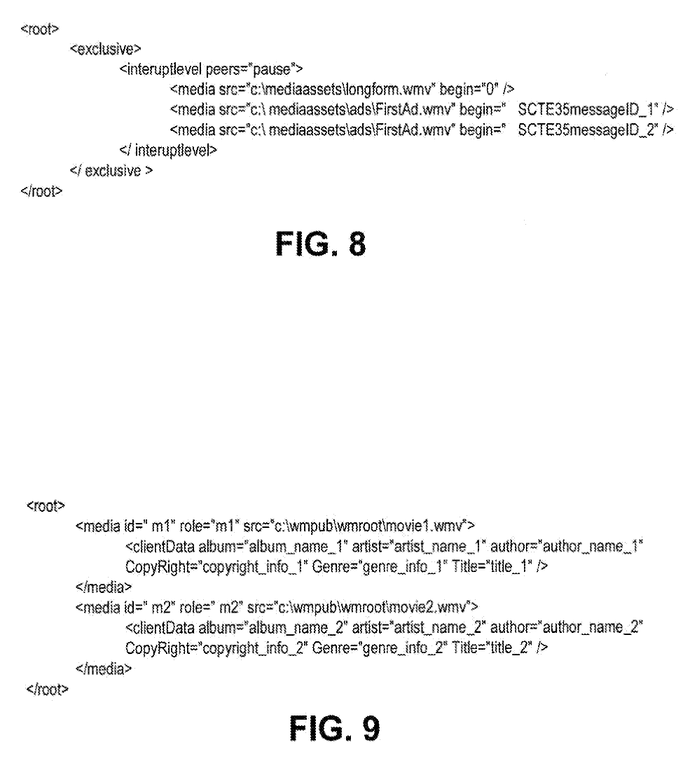

Consistent with the set of XML nodes and attributes described above in Tables 1 and 2, FIG. 8 is one example of pseudo-code that demonstrates how a playlist might be constructed for an arbitrary playout device. This is by no means the exclusive format the VPS is capable of delivering. As a further example, FIG. 9 depicts an example of a playlist that can be generated for driving another type of playout device, such as a Media Series 9™ decoder available from Microsoft Corporation of Redmond, Wash.

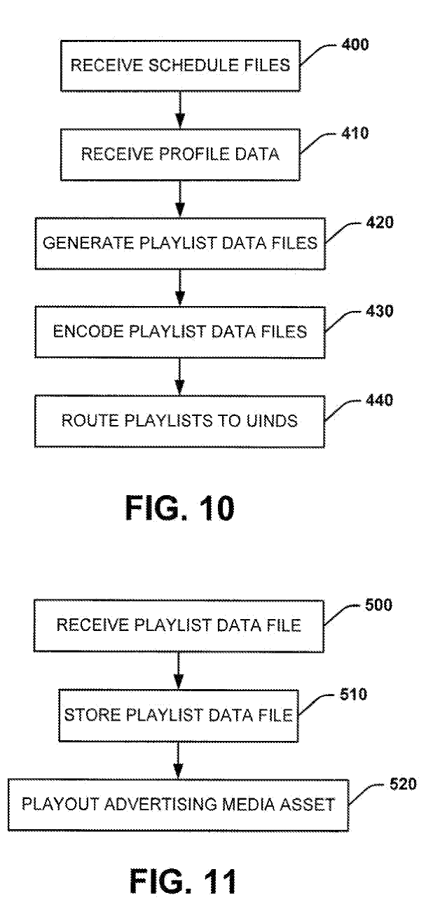

In view of the structural and functional features described above, certain methods will be better appreciated with reference to FIGS. 10 and 11. It is to be understood and appreciated that the illustrated actions, in other embodiments, may occur in different orders or concurrently with other actions. Moreover, not all features illustrated in FIGS. 10 and 11 may be required to implement a method according to the subject invention. It is to be further understood that the following methodology can be implemented in hardware (e.g., one or more processors, such as in a computer or other processing apparatus), software (e.g., stored in a computer readable medium or as executable instructions running on one or more processors), or as a combination of hardware and software.

FIG. 10 is a flow diagram depicting a method for generating and distributing pre-crafted playlists according to an aspect of the invention. The method begins at 400, in which a plurality of schedule files are received. The schedule files include scheduling information for at least one respective advertising media asset and typically a plurality of assets. Target attribute data is associated with each of the plurality of schedule files to identify at least one characteristic of an intended target audience of media content represented in each of the plurality of schedule files. The schedule files can be provided in a variety of formats and syntaxes.

At 410, profile data associated with each of a plurality of uniquely identifiable network devices is received. The profile data can characterize known attributes (e.g., defined categories of market segments and/or identifiable characteristics thereof) of an audience serviced by each of the plurality of uniquely identifiable network devices. At 420, a plurality of playlist data files are generated based on analysis of the target data and the profile data. Each of the plurality of playlist data files includes scheduling information for at least one respective advertising media asset scheduled for playing out by at least one of the plurality of uniquely identifiable network devices.

At 430, the playlist data files can be encoded into a format that is compatible with the uniquely identifiable network device to which each respective playlist data files is to be sent. At 440, the encoded playlist data files are routed to at least one UIND through an associated network, such as described herein

FIG. 11 depicts an example of a basic method demonstrating how a given UIND can utilize a playlist data file in connection with presentation of media. Those skilled in the art will appreciate various other possible implementations for a method of playing out media based on schedule data contained in a playlist data file based on the teachings herein.

At 500, the routed playlist data file is received by the selected UINDs. The playlist data file further may be decoded into a useable format as well as to identify which media assets are required by the schedule data contained in the playlist data file. At 510, the playlist data file is stored in memory, which may local or remote relative to the UNID. The advertising media assets and other media (e.g., primary media assets) may be uploaded to local memory to facilitate playout of such media. Alternatively, the scheduled media assets located and be acquired remotely (e.g., from a media source or server via a network).

At 520, one or more advertising media assets are played out by a given one of the plurality of UINDs based on scheduling data contained in the playlist data file that has been received by given UIND. Appropriate advertising media assets can be loaded and playout out according to event identifiers listed in the scheduling data. In certain circumstances, a UIND can requesting an update to the playlist data file prior to playing out a media asset, such as in response to the detection of the event identifier. The promotion scheduler can in turn return an updated version of the targeted playlist data file, such as where one or more parts of the schedule have been modified since the playlist data file had been generated. The UIND can employ the updated playlist data file to playout scheduled advertising media.

What have been described above are examples and embodiments of the invention. It is, of course, not possible to describe every conceivable combination of components or methodologies for purposes of describing the invention, but one of ordinary skill in the art will recognize that many further combinations and permutations of the present invention are possible. Accordingly, the invention is intended to embrace all such alterations, modifications and variations that fall within the scope of the appended claims. In the claims, unless otherwise indicated, the article “a” is to refer to “one or more than one.”

What is claimed is:

1. A method to facilitate targeted advertising, comprising:
receiving a plurality of schedule files that include scheduling information for at least one respective advertising media asset, target attribute data being associated with each of the plurality of schedule files to identify at least one characteristic of an intended target audience of media content represented in each of the plurality of schedule files;
receiving profile data associated with each of a plurality of uniquely identifiable network devices, the profile data characterizing known attributes of an audience serviced by each of the plurality of uniquely identifiable network devices; and
generating a plurality of playlist data files based on analysis of the target data and the profile data, each of the plurality of playlist data files including the scheduling information for the at least one respective advertising media asset scheduled for playing out by at least one of the plurality of uniquely identifiable network devices.

2. The method of claim 1, further comprising indexing each of the plurality of schedule files according to the associated target attribute data to provide an indexed set of schedule files; and
rationalizing the profile data relative to the indexed set of schedule files to determine which of the plurality of schedule files is to be sent in a playlist data file to each of the uniquely identifiable network devices.

3. The method of claim 2, further comprising encoding each of the plurality of playlist data files into a format that is compatible with the uniquely identifiable network device to which each respective playlist data files is to be sent.

4. The method of claim 1, routing each of the plurality of playlist data files to at least one uniquely identifiable network device through an associated network.

5. The method of claim 4, further comprising receiving and storing at least one of the plurality of playlist data files of memory at each of the plurality of uniquely identifiable network devices.

6. The method of claim 5, further comprising playing out the at least one respective advertising media asset by a given one of the plurality of uniquely identifiable network devices based on scheduling data contained in the playlist data file routed to the given one of the plurality of uniquely identifiable network devices.

7. The method of claim 6, wherein the playing out further comprises:
pausing an output stream of a primary media asset based on the scheduling data;
injecting the at least one respective advertising media asset from the memory as streamable media into the output stream based on the scheduling data; and
resuming the streaming of the primary media asset as the output stream upon completion of the at least one respective advertising media asset.

8. The method of claim 7, further comprising:
detecting an event identifier encoded in the output stream being played out by the given one of the plurality of uniquely identifiable network devices;
evaluating the event identifier relative to at least one corresponding identifier in the playlist data file of the given one of the plurality of uniquely identifiable network devices; and
if the event identifier substantially matches the at least one corresponding identifier, loading the at least one respective advertising media asset for injection into the output stream.

9. The method of claim 8, further comprising requesting an update to the playlist data file by the given one of the plurality of uniquely identifiable network devices in response to the detection of the event identifier.

10. The method of claim 7, wherein the scheduling data further comprises:
program identifying data that identifies at least a substantial portion of a primary media asset;
adcopy identifying data that identifies the at least one respective advertising media asset; and
timing data that identifies timing and sequencing information for presentation of the at least a substantial portion of a primary media asset and the at least one respective advertising media asset.

11. The method of claim 7, wherein the scheduling data further comprises:
program identifying data that identifies a plurality of primary media assets;
adcopy identifying data that identifies a plurality of advertising media assets; and
timing data that identifies timing and sequencing information for presentation of the plurality of primary media assets and the plurality of advertising media assets.

12. The method of claim 6, wherein at least one of the plurality of uniquely identifiable network devices comprises a digital signage system, the method further comprising:
storing a plurality of advertising media assets in associated memory; and
playing out the stored advertising media assets from the associated memory according to the scheduling data in the playlist data file received and stored in the digital signage system.

13. The method of claim 5, further comprising updating a corresponding playlist data file in the memory of the at least one of the plurality of uniquely identifiable network devices to include scheduling changes made in the schedule file that was utilized to generate the corresponding playlist data file.

14. The method of claim 1, wherein the known attributes of the audience comprise at least one of demographic information and geographic information.

15. A system to facilitate targeted advertising comprising:
at least one scheduling source that provides a plurality of schedule files, target attribute data being associated with each of the plurality of schedule files to identify at least one attribute of an intended target audience for media content defined by scheduling data in each of the plurality of schedule files;
profile data being defined for each of the plurality of uniquely identifiable network devices to identify known attributes of consumers serviced by each of the plurality of uniquely identifiable network devices; and
a promotion scheduler in communication with a plurality of uniquely identifiable network devices, the promotion scheduler generating a plurality of targeted playlist data files based on analysis of the target attribute data and the profile data, each of the plurality of playlist data files including scheduling data for playing out at least one media asset by at least one of the plurality of uniquely identifiable network devices.

16. The system of claim 15, further comprising a playlist encoder programmed to format each playlist according to format requirements of each of the plurality of uniquely identifiable network devices to which each respective playlist data file is to be sent.

17. The system of claim 16, further comprising a router configured to route each of the plurality of playlist data files to at least one of the plurality of uniquely identifiable network devices.

18. The system of claim 15, further comprising a plurality of uniquely identifiable digital signage systems in communication with the promotion scheduler, each of the digital signage systems comprising a playout device that provides advertising media assets to a display according to the scheduling data in the playlist routed to each respective digital signage system.

19. The system of claim 15, further comprising a plurality of uniquely identifiable distribution systems, each including a playout device configured to transmit an output stream of a primary media asset based on the scheduling data in the playlist data file routed to each respective distribution system, the playout device of each of the plurality of distribution systems being programmed to inject at least one advertising media asset into the output stream based on the scheduling data, the playout device resuming the streaming of the primary media asset as the output stream upon completion of the at least one advertising media asset.

20. The system of claim 19, wherein the promotion scheduler is programmed to dynamically modify at least one parameter in a selected playlist data file in response to changes in a corresponding schedule data file that occur after the selected playlist data file has been sent to at least one of the plurality of uniquely identifiable network devices, an updated version of the selected playlist data file being sent to the at least one of the plurality of uniquely identifiable network devices.

21. The system of claim 19, wherein the promotion scheduler is programmed to generate an ad-enabled primary media asset, the ad-enabled primary media asset being encoded with predetermined event identifiers, each of the plurality of playlist data files including at least a substantial portion of the predetermined event identifiers to at least one corresponding advertising media asset that is to be inserted selectively into the primary media asset according to the scheduling data.

22. A system to facilitate targeted advertising comprising:
means for ingesting a plurality of schedule files that include scheduling information for at least one respective advertising media asset, target attribute data being associated with each of the plurality of schedule files to identify at least one characteristic of an intended target audience of the at least one media asset in each of the plurality of schedule files;
means for managing profile data associated with each of a plurality of uniquely identifiable network devices, the profile data characterizing known attributes of an audience serviced by each of the plurality of uniquely identifiable network devices; and
means for generating a plurality of playlist data files based on analysis of the target data and the profile data, each of the plurality of playlist data files including scheduling data for the at least one respective advertising media asset scheduled for playout by at least one of the plurality of uniquely identifiable network devices.
